(19) United States
(12) Patent Application Publication
(10) Pub. No.: US 2026/0106861 A1
(43) Pub. Date: Apr. 16, 2026

(54) METHOD AND DEVICE FOR ENCRYPTING OR DECRYPTING A VIDEO FILE

(71) Applicant: TP-Link Systems Inc., IRVINE, CA (US)

(72) Inventors: Kun ZHANG, Shanghai (CN); Yiyang LIU, Shanghai (CN); Mingyi CONG, Shanghai (CN)

(73) Assignee: TP-Link Systems Inc., IRVINE, CA (US)

(21) Appl. No.: 18/918,005

(22) Filed: Oct. 16, 2024

(51) Int. Cl. H04L 9/40; H04N 19/136; H04N 19/172; H04N 19/467

(52) U.S. Cl. CPC H04L 63/0457; H04N 19/136; H04N 19/172; H04N 19/467

(57) ABSTRACT

The present disclosure provides a method and device for encrypting or decrypting a video file. The method for encrypting the video file includes: generating index information and video information for each of a plurality of frames of a video file to be encrypted based on video data for each of the plurality of frames; encapsulating the index information and the video information for each of the plurality of frames into an encapsulation format of the video file; and encrypting, for one or more frames of interest among the plurality of frames, the index information in the encapsulation format of the video file using a key.

### TECHNICAL FIELD

The present disclosure relates to file encryption and decryption techniques, and more specifically, to a method and device for encrypting or decrypting a video file.

### BACKGROUND

In the age of digital media, an increasing number of users deploy their surveillance cameras to facilitate local or remote monitoring. To ensure users can playback the surveillance video at any time, most manufacturers employ on-device storage to save video files captured by the cameras. However, this approach poses a heightened risk of video data leakage in the event of the loss or unauthorized use of the cameras. Consequently, it is important to devise a video encryption approach to safeguard the security of video data stored on storage media.

### SUMMARY

In view of the above problems, the present disclosure provides a method, a device and a computer program product for encrypting or decrypting a video file.

According to one embodiment of the present disclosure, there is provided a method for encrypting a video file, comprising: generating index information and video information for each of a plurality of frames of a video file to be encrypted based on video data for each of the plurality of frames; encapsulating the index information and the video information for each of the plurality of frames into an encapsulation format of the video file; and encrypting, for one or more frames of interest among the plurality of frames, the index information in the encapsulation format of the video file using a key.

According to another embodiment of the present disclosure, there is provided a method for decrypting a video file, comprising: obtaining a video file encapsulated using an encapsulation format; decapsulating index information and video information for each of a plurality of frames included in the video file according to the encapsulation format, wherein the index information of one or more frames of interest is encrypted using a key; decrypting the index information for the one or more frames of interest using the key; and generating decrypted video data of the video file based on the index information and the video information for each of the plurality of frames.

According to yet another embodiment of the present disclosure, there is provided a device for encrypting a video file, comprising: one or more processors; a memory coupled to at least one of the processors; and a set of computer program instructions stored in the memory, which, when executed by at least one of the processors, perform actions of: generating index information and video information for each of a plurality of frames of a video file to be encrypted based on video data for each of the plurality of frames; encapsulating the index information and the video information for each of the plurality of frames into an encapsulation format of the video file; and encrypting, for one or more frames of interest among the plurality of frames, the index information in the encapsulation format of the video file using a key.

According to yet another embodiment of the present disclosure, there is provided a device for decrypting a video file, comprising: one or more processors; a memory coupled to at least one of the processors; and a set of computer program instructions stored in the memory, which, when executed by at least one of the processors, perform actions of: obtaining a video file encapsulated using an encapsulation format; decapsulating index information and video information for each of a plurality of frames included in the video file according to the encapsulation format, wherein the index information of one or more frames of interest is encrypted using a key; decrypting the index information for the one or more frames of interest using the key; and generating decrypted video data of the video file based on the index information and the video information for each of the plurality of frames.

According to yet another embodiment of the present disclosure, there is provided a computer program product for encrypting or decrypting a video file, the computer program product comprising a non-transitory computer readable storage medium having program instructions embodied therewith, the program instructions executable by a processor of a device to cause the processor to perform the above methods for encrypting or decrypting a video file.

At least based on the above embodiments of the present disclosure, the video file encryption and decryption approach based on the video file encapsulation format ensures the security of video file encryption while significantly reducing the amount of data that needs to be processed during encryption and decryption, which greatly reduces the overhead and waiting time for the encryption and decryption process, thereby optimizing the user experience.

### BRIEF DESCRIPTION OF THE DRAWINGS

The above and other objects, features and advantages of the present disclosure will become more apparent by describing embodiments of the present disclosure in more detail in conjunction with accompanying drawings. The drawings are used to provide a further understanding of the embodiments of the present disclosure and constitute a part of the specification. The drawings together with the embodiments of the present disclosure are used to explain the present disclosure, but do not constitute a limitation on the present disclosure. In the drawings, unless otherwise explicitly indicated, the same reference numerals refer to the same components, steps or elements.

FIG. 1 illustrates an exemplary schematic diagram of a scenario for encrypting or decrypting video files according to an embodiment of the present disclosure.

FIG. 2A illustrates an exemplary schematic diagram of an encapsulation format for use in video file encryption/decryption according to an embodiment of the present disclosure.

FIG. 2B illustrates a schematic diagram of a first example of encrypting a video file based on an encapsulation format according to an embodiment of the present disclosure.

FIG. 2C illustrates a schematic diagram of a second example of encrypting a video file based on an encapsulation format according to an embodiment of the present disclosure.

FIG. 2D illustrates a schematic diagram of a third example of encrypting a video file based on an encapsulation format according to an embodiment of the present disclosure.

FIG. 3 illustrates a schematic diagram of generating a key for encrypting a video file according to an embodiment of the present disclosure.

FIG. 4 illustrates a schematic diagram of encrypting and decrypting a video file based on an encapsulation format according to an embodiment of the present disclosure.

FIG. 5 illustrates a flowchart of a computer-implemented method for encrypting a video file according to an embodiment of the present disclosure.

FIG. 6 illustrates a flowchart of a computer-implemented method for decrypting a video file according to an embodiment of the present disclosure.

FIG. 7 is an exemplary block diagram illustrating a computing device according to embodiments of the disclosure.

### DETAILED DESCRIPTION

The technical solution of the present disclosure will be clearly described below in conjunction with accompanying drawings. Obviously, the described embodiments are part of embodiments of the present disclosure, but not all of them. Based on the embodiments in the present disclosure, all other embodiments obtained by ordinary skilled in the art without making any creative efforts fall within the scope of protection of the present disclosure.

In the description of the present disclosure, it should be noted that orientations or positional relationships indicated by terms such as "center", "upper", "lower", "left", "right", "vertical", "horizontal", "inside" and "outside" are based on orientations or positional relationships shown in the drawings, only for the convenience of describing the present disclosure and simplifying the description, instead of indicating or implying the indicated device or element must have a particular orientation. In addition, terms such as "first", "second" and "third" are only for descriptive purposes, and cannot be understood as indicating or implying relative importance. Likewise, words like "a", "an" or "the" do not represent a quantity limit, but represent an existence of at least one. Words like "include" or "comprise" mean that an element or an object in front of the said word encompasses those ones listed following the said word and their equivalents, without excluding other elements or objects. Words like "connect" or "link" are not limited to physical or mechanical connections, but may include electrical connections, whether direct or indirect.

In the description of the present disclosure, it should be noted that, unless otherwise explicitly specified and limited, terms such as "mount", "link" and "connect" should be understood in a broad sense. For example, such terms may refer to being fixedly connected, or detachably connected, or integrally connected; may refer to being mechanically connected, or electrically connected; may refer to being directly connected, or indirectly connected via an intermediate medium, or internally connected inside two elements. For ordinary skilled in the art, the meanings of the above terms in the present disclosure may be understood on a case-by-case basis. Technical features involved in different embodiments of the present disclosure described below may be combined with each other as long as no conflicts occurs therebetween.

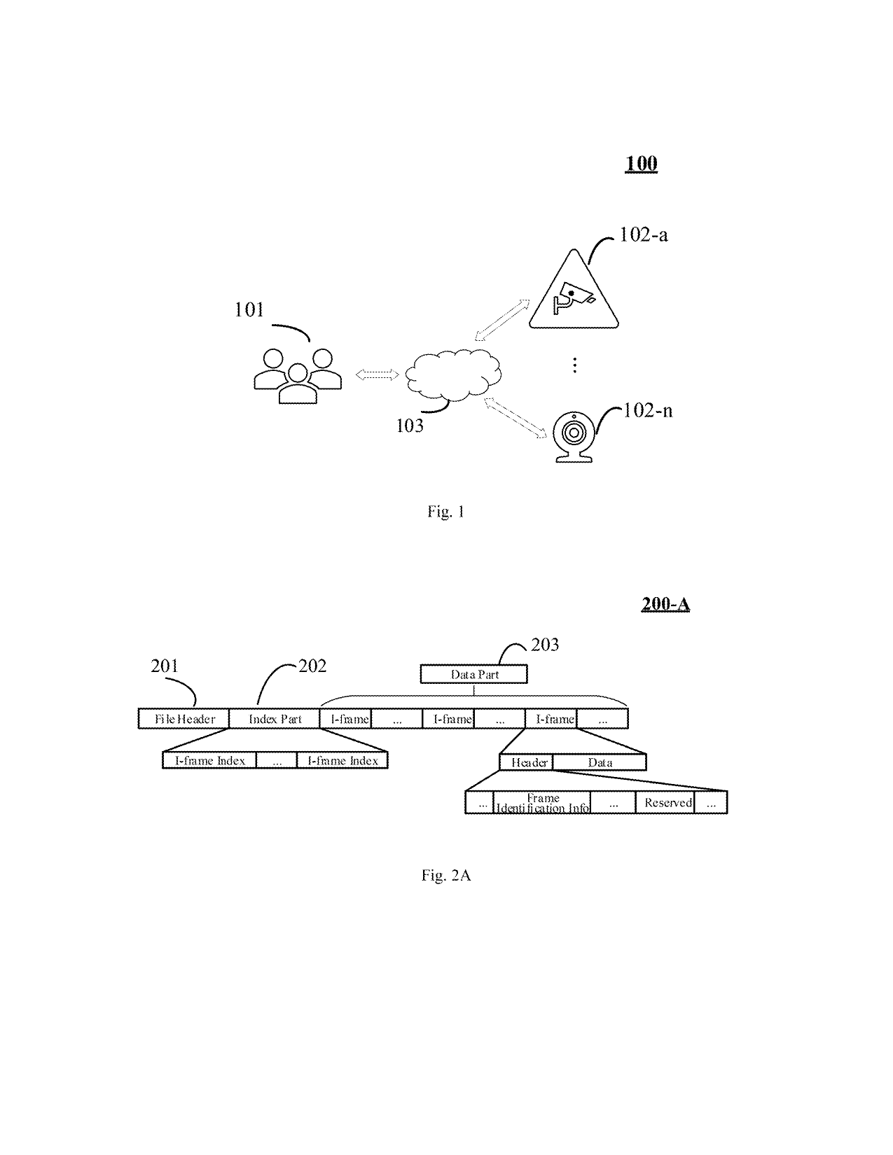

FIG. 1 illustrates an exemplary schematic diagram of a scenario for encrypting or decrypting video files according to an embodiment of the present disclosure.

As shown in the scenario 100 of FIG. 1, one or more users 101 may deploy one or more video capturing devices 102-a to 102-n (hereinafter collectively referred to as video capturing device 102, such as surveillance cameras) at various sites that require monitoring. Additionally, users can configure the surveillance cameras, e.g., account login, capturing parameter settings, file storage settings, encryption settings, password and encryption key settings, and other settings or configurations through the cloud 103 or any other communication mechanism using their portable electronic devices, such as smartphones.

For instance, a user may place one or more surveillance cameras at various locations within his or her home to remotely monitor potential dangers or review historical surveillance footage. Similarly, a security team may install one or more surveillance cameras in areas that need monitoring (e.g., residential complexes, elevator lobbies, public spaces and the like) for real-time surveillance or subsequent playback of the surveillance footage. The video capturing device 102 can capture and save video files locally (e.g., on-board storage of the surveillance camera or a removable storage device, such as a SD card installed therein), allowing users to replay the captured video files at any time. To ensure the security of video data against leaks and unauthorized use, the video capturing device 102 may encrypt the captured video files before storage in the on-board storage or the removable storage device. Subsequently, when users want to playback the recorded videos, they can send a request for playback through the cloud 103 and obtain the decrypted video files provided by the video capturing device 102 for viewing. The details for encrypting and decrypting video files are described hereinafter.

It should be noted that the above-mentioned scenario for encrypting or decrypting video files in FIG. 1 is only exemplary, the application scenarios for encrypting or decrypting video files according to the present disclosure are not limited thereto. For example, although the above descriptions are provided in case of configuring the video capturing device and accessing the captured video files (which may be encrypted as needed) through the cloud, the present disclosure is also applicable to the case that configuring the video capturing device and accessing the video files are performed locally without communicating through the cloud. In addition, although the descriptions are directed to the encryption and decryption operations on the video capturing device, it can be understood that the proposed encryption and decryption approach of the present disclosure can also be used in any other type of computing device which may be able to encrypt or decrypt video files captured by itself and stored in the storage of itself or external storage it has access to or any other type of computing device which may be able to encrypt or decrypt video files copied from other computing devices.

Although several encryption schemes for video files have been developed, current schemes predominantly focus on video coding schemes, and performance and overhead thereof are typically assessed based on the encryption and decryption costs for a small number of video files or several video segments in real-time broadcast scenarios. However, in the surveillance camera usage scenarios described above where local video data can easily reach hundreds of gigabytes as well as other cases for which there may be large amount of video files to encrypt, employing such encryption schemes would result in an unmanageably large volume of data to process during encryption and decryption. This overhead is unacceptable, especially when computing resources of the computing device are limited for the encryption and decryption.

Conventionally, video file encryption schemes mainly include video coding-based encryption, network transmission format-based encryption, and file system-based encryption. For instance, the video coding-based encryption involves intra-frame prediction modes, inter-frame prediction modes, etc., which may be used to encrypt the video files during the video coding phase, such as by encrypting coding parameters like transform matrices used in intra-frame and inter-frame predictions. However, this approach results in a large amount of data to be encrypted, leading to significant overhead of the encryption and decryption. As another example, the network transmission format-based encryption ensures that video streams are not accessed unauthorizedly during transit, but it is not suitable for local storage scenarios. Additionally, the file system-based encryption includes file hiding, metadata encryption and other encryptions at file system level, but it does not involve encryptions at file level, which fails to prevent file recovery techniques like disk repair. For example, even if a file is encrypted using the file system-based encryption approach, if an attacker can restore the files through disk scanning and file format matching, the encryption measures may be circumvented.

At least in view of the above technical problems, the present disclosure proposes a method for encrypting or decrypting video files based on the video file encapsulation format, which involves security related processing on an index part and optionally on a data part of the video file encapsulation format. For example, with respect to one or more video frames of the video file (e.g., obtained after video encoding is completed), the index information in the index part of the video file encapsulation format can be encrypted for the video frames, and optionally, the frame encoding parameters of the data part (such as, the frame identification information included in the frame header information, which will be described later) of the video file encapsulation format can be obfuscated for the video frames, achieving video file encryption at a relatively low cost and computational overhead. On the other hand, the present disclosure proposes generating an encryption/decryption key based on both the device information of a capturing device (e.g., a surveillance camera) and the user information (e.g., user-input string), such that the security of the encrypted video files is further enhanced, due to the reason that different keys can be generated for different users and different capturing devices and can also be dynamically changed by the user at any time.

According to the video file encryption based on the video file encapsulation format of the present disclosure, the security of video file encryption can be ensured while significantly reducing the amount of data that needs to be processed during encryption and decryption processes, which greatly reduces overhead and waiting time for the encryption and decryption, and thereby optimizing the user experience.

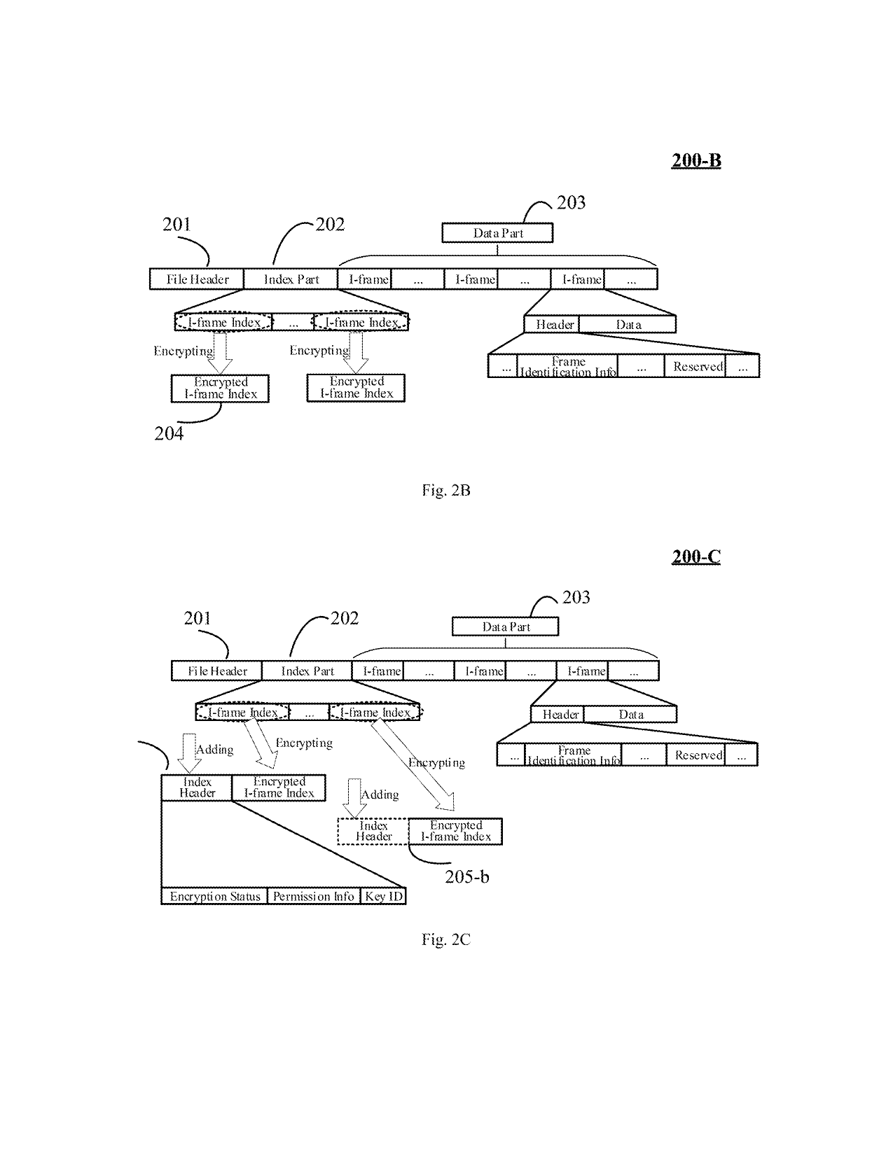

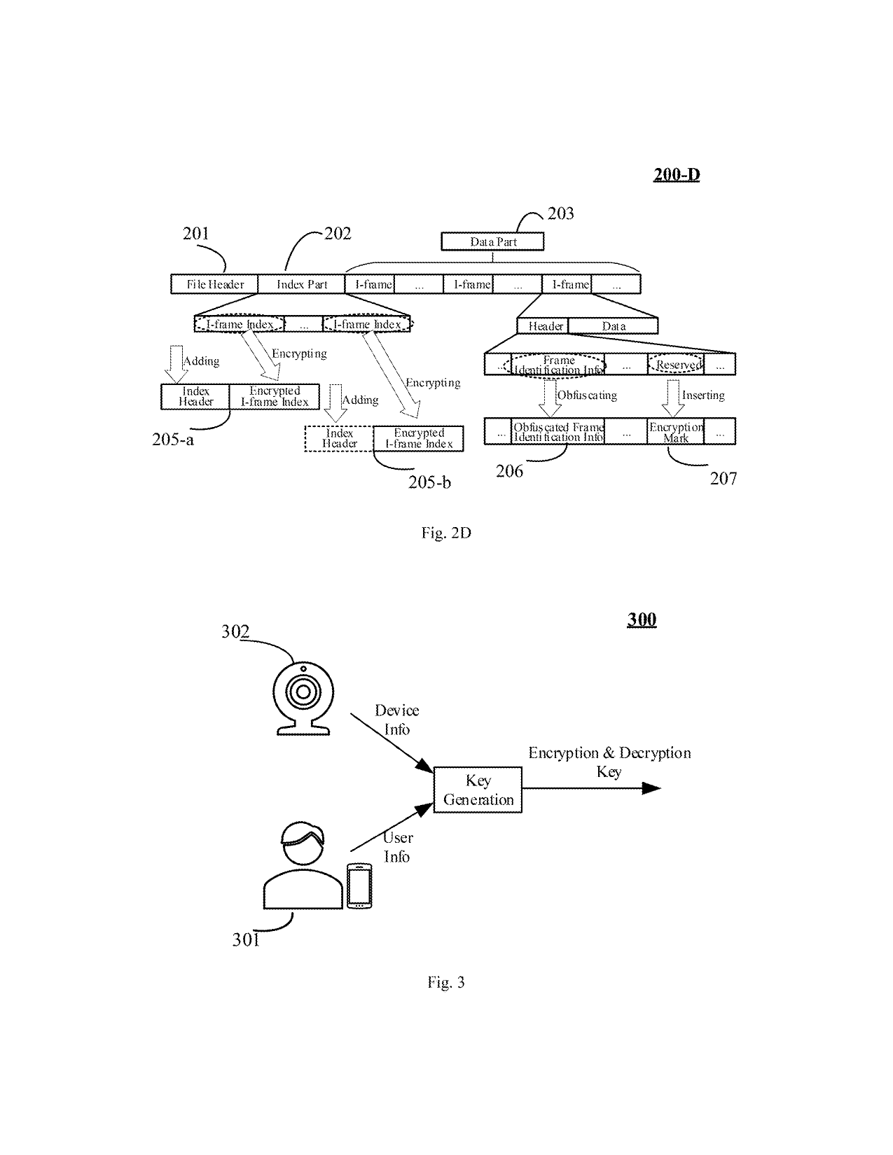

FIG. 2A illustrates an exemplary schematic diagram of an encapsulation format for use in video file encryption/decryption according to an embodiment of the present disclosure.

As shown in the video file encapsulation format 200-A of FIG. 2A, it primarily comprises a file header 201, an index part 202, and a data part 203. It is understood that after a captured video file is encoded, the video data for each of a plurality of frames of the video file can be obtained as a video stream. For example, the video data for each of the plurality of frames of the video file can be obtained by encoding raw video data captured by a video capturing device. For instance, the plurality of frames within this video stream may include one or more intra frames (I-frames), one or more predictive frames (P-frames), and one or more bi-directional predictive frames (B-frames). Subsequently, to encapsulate the video data into a video file, the index information and video information for each frame, which are to be filled into the index part 202 and the data part 203 respectively, can be generated.

For examples, H.264 video coding technique and MP4 video encapsulation format are used as illustrative examples in the descriptions hereinafter. In the following descriptions, it is assumed that the obtained video data includes video data for each of a series of I-frame, P-frame, B-frame, P-frame, P-frame, I-frame, P-frame, …, I-frame arranged in a certain order of the plurality of frames. However, those skilled in the art will understand that the video encoding and decoding can also be performed using standards such as H.261, H.263, H.265, H.266, etc., defined by the International Telecommunication Union (ITU), or a series of MPEG standards defined by the International Organization for Standardization (ISO). Also, video file encapsulation formats such as AVI, MKV, MOV, RM/RMVB, etc., can be used to encapsulate the encoded video stream into a video file. Moreover, the arrangement order of multiple frames in the obtained video stream can differ from the example provided. The present disclosure does not limit the specific coding method, encapsulation format, or frame arrangement order.

As shown in FIG. 2A, the file header 201 indicates various file-related information, such as, file type, file size, file creation and modification times, attribute information, and other general information for the video file of the specified encapsulation format.

The index part 202 contains the locations of the various video frames within the video file to provide the ability to locate the actual video data of each frame within the video file based on its index information (e.g., offset information) to allow for video data access of each frame. For example, the index information of each frame can be in a form of a fixed-size character indicating or recording the offset information for that frame. For instance, the index part 202 may contain index information for each frame of the series of frames arranged in a certain order, such as in the order of I-frame, P-frame, B-frame, P-frame, P-frame, I-frame, P-frame, …, I-frame, as mentioned above. For simplicity, only the index information for two I-frames among the multiple frames is shown, which is simply illustrated as "I-frame Index" in FIG. 2A, while "P-frame Index" and "B-frame Index" are not explicitly shown in FIG. 2A.

The data part 203 contains the actual video data and is therefore the main body of the file, storing the video information for each frame of the video file, also arranged in a certain order of the frames (e.g., in the same order of I-frame, P-frame, B-frame, P-frame, P-frame, I-frame, P-frame, …, I-frame, as mentioned above). For simplicity, only the video information for three I-frames among the multiple frames is shown. Additionally, as illustrated for the third I-frame, the video information of each frame (including such as I-frame, P-frame and B-frame) is further divided into frame header information (simply shown as "Header" in FIG. 2A) and frame data information (simply shown as "Data" in FIG. 2A). Furthermore, the frame header information of each frame (including such as I-frame, P-frame and B-frame) at least records the coding parameters for that frame, such as frame identification information (simply shown as "Frame Identification Info" in FIG. 2A) used to distinguish between a plurality of frame types (i.e., types of I-frames, P-frames, B-frames), and there are also some reserved bits (simply shown as "Reserved" in FIG. 2A) in the frame header information for future expansion.

It is understood that the approach of generating the index information and the video information to be filled into the index part 202 and the video part 203 of the video file encapsulation format 200-A based on the obtained video stream is known to those skilled in the art, and the present disclosure does not limit the generation method of the index information and the video information, as long as the needed information is generated in accordance with the requirements of the specified video encapsulation format. The present disclosure does not describe in detail the generation process of the index information and video information to avoid obscuring the descriptions of encryption/decryption approaches of the present disclosure.

FIG. 2B illustrates a schematic diagram of a first example of encrypting a video file based on an encapsulation format according to an embodiment of the present disclosure.

As depicted in scenario 200-B of FIG. 2B, the video file encryption described in FIG. 2B is based on the same video encapsulation format as in FIG. 2A. The file encryption in FIG. 2B builds upon the encapsulation format 200-A of FIG. 2A, involving the encryption of index information within the index part 202 for one or more frames of interest among multiple frames of a video file, thereby achieving encryption of the video file.

As described in FIG. 2B, after obtaining video data for each of the plurality of frames of a video file to be encrypted, the index information and the video information for each of the plurality of frames can be generated based on the video data for each of the plurality of frames, in accordance with the requirements of the selected encapsulation format. Subsequently, the index information and video information for each of the plurality of frames can be encapsulated into an encapsulation format of the video file, as described in a similar manner to FIG. 2A.

Thereafter, encryption can be performed on the index information within the index part 202 for one or more frames of interest among multiple frames of the video file, and the original index information for the frames of interest in the encapsulation format can be replaced with the encrypted index information, thereby achieving file encryption. The encryption can be performed using various known encryption algorithms, such as AES (Advanced Encryption Standard), DES (Data Encryption Standard), SHA (Secure Hash Algorithm), MD5 (Message Digest Algorithm 5), etc., which is not limited in the present disclosure. For example, taking the two I-frames in FIG. 2B as an example, the index information thereof can be encrypted using a key to obtain the encrypted index information (as indicated by reference numeral 204 "Encrypted I-frame index" in FIG. 2B). Since the specific video information of each video frame in the data part 203 can only be located and found based on the index information for that frame included in the index part 202, by encrypting the index information of the video frames in the present disclosure, attackers or unauthorized users who have copied the encrypted video file will find it difficult to locate specific video data due to the lack of index information, thus preventing decryption and ensuring security.

According to this embodiment, by encrypting the index information of video frames, common video players on the market are unable to parse the meaning of the decrypted index information of the index part of the video file and therefore cannot locate and parse the detailed video information of the data part of the video file, and thus cannot playback the encrypted video file. Similarly, common video file recovery software, due to the inability to parse the meaning of the encrypted index information of the index part of the video file, also cannot recover the content of the video file, thereby ensuring the security of the encrypted video file. Moreover, in the present disclosure, the overhead of encryption/decryption processing is considered, so only the index part of the video file, rather than the data part (which contains a significantly large amount of data), is processed. Compared to the existing method of directly encrypting all actual video data for the data part, this significantly reduces the computational overhead, for example, reducing the time overhead during decryption to about 2%.

According to one example of this embodiment, the one or more frames of interest correspond to all the plurality of frames of the video file to be encrypted. Accordingly, the index information for each I-frame, P-frame, and B-frame needs to be encrypted, and the original unencrypted index information of each frame in the encapsulation format is replaced with the encrypted index information of each frame to achieve encryption of the video file.

According to another example of this embodiment, the one or more frames of interest correspond to the I-frames within the plurality of frames. It is understood that I-frames are key frames in the video stream, and the content of the I-frame can be restored only by the encoded data corresponding to the I-frame. On the other hand, to restore the P-frame and B-frame generated by inter-frame prediction, the image data of the reference frame (i.e., I-frame) is needed, and the content of the P-frame and B-frame cannot be restored by the encoded data of the P-frame and B-frame alone. If an attacker cannot crack the key I-frame, it is difficult to crack the content of the video file. Therefore, only the index information of the I-frame is encrypted, while the index information of the remaining video frames (e.g., B-frames and P-frames) remains unchanged, which can further reduce the computational load of the encryption and decryption process. Accordingly, the index information for each I-frame needs to be encrypted, and then the original unencrypted index information for each of the I-frames is replaced with the encrypted I-frame index information in the encapsulation format.

In this manner, the index part 202 of the encrypted file includes the encrypted index information for the frames of interest and the original unencrypted index information for the remaining frames, while the data part 203 remains unchanged.

It should be noted that the operations for decryption of video file are counterpart operations to those for encryption of video file, and therefore the processing in the decryption process will be briefly described below. For example, after obtaining a video file encapsulated using an encapsulation format, the index information and video information for each of the plurality of frames included in the video file can be decapsulated according to the encapsulation format. For example, the video file can be decapsulated into index information for each frame corresponding to the index part 202 and video information for each frame corresponding to the data part 203. As described above, the index information of one or more frames of interest was encrypted using a key during the encryption process for the video file. Therefore, for each frame of interest, the index information can be decrypted using the key, which is the same as in the encryption process. Accordingly, decrypted video data of the video file can be generated based on the index information and the video information for each of the plurality of frames.

According to an example of this embodiment, a user may wish to directly access the encrypted video file stored on the storage (such as SD card) in the camera for local viewing. In this case, the decrypted index information for each frame of interest, the original unencrypted index information for each remaining frame, as well as the video information for each of the plurality of frames can be encapsulated into a non-encrypted video file according to the original order of the plurality of frames and written back to the storage of the camera. For example, the encrypted index information in the encapsulation format of the encrypted file for the frames of interest can be replaced with the decrypted index information thereof, and the resulting encapsulated file can be written back to the storage (e.g., as a decrypted version of the encrypted video file), such that the decrypted video file can be copied to a computing device (such as PC or mobile phone) of the user, which may be different from the video capturing device of the user, for video players installed on the computing device to read and parse the decrypted video file and for the user’s local viewing on his or her computing device.

According to another example of this embodiment, a user may wish to remotely view the video files stored on the storage medium. In this case, decryption can be performed on the camera side, and the decrypted video stream can be pushed to the user for remote viewing. For example, based on the index information for each frame (i.e., the decrypted index information for the frames of interest and the original unencrypted index information for the remaining frames) in the index part, the video information (including the frame header information and the frame data information of each frame) corresponding to each piece of index information can be located and found in the data part, and the actual video data for the plurality of framers can be parsed according to the frame header information in the video information of each video frame, and the resulting video stream can be pushed to the user based on the video streaming techniques for remote viewing.

It is understood that the above viewing scenarios for local viewing and remote viewing are exemplary, and the present disclosure is not limited thereto.

FIG. 2C illustrates a schematic diagram of a second example of encrypting a video file based on an encapsulation format according to an embodiment of the present disclosure.

As shown in scenario 200-C of FIG. 2C, the video encryption processing described in FIG. 2C is essentially the same as that in FIG. 2B, both being conducted based on a video encapsulation format. The distinction between FIGS. 2C and 2B lies in the further inclusion of index header information within the index part 202 for the frames of interest.

As described in FIG. 2C and indicated by reference numerals 205-a and 205-b, for the frames of interest, in addition to the encrypted index information (as shown by "Encrypted I-frame Index"), there is also index header information (as shown by "Index Header") included, which records information such as encryption status, permission information, and key identifier that aids in the encryption/decryption process, as detailed later.

In a first aspect of the embodiment, the index header information includes an encryption status for the one or more frames of interest. For instance, since the I-frame, being a frame of interest, has its index information encrypted, its encrypted status can be recorded in the index header information of that I-frame. Thus, during the decryption process, whether to decrypt the index information following the index header information can be confirmed based on the status indicated by the encryption status. If the frame of interest requires decryption for its index information, the process proceeds to locate the key from a key management module, and handle the index information encryption; if not, decryption is skipped. In this way, index information decryption can be efficiently done according to the indicated encryption status.

In a second aspect of the embodiment, the index header information includes permission information for the video file to be encrypted. For example, considering the case of the video stream obtained from a surveillance camera, different users of the camera (such as different members of a security team) can be granted different playback permissions. For instance, access to footage captured from specific locations where cameras are deployed may be restricted to certain individuals, while others may not have such permissions. Similarly, access to video clips captured within certain time periods (e.g., specific time of a day, or specific day of a week, and otherwise specified durations) may be limited to certain individuals. Therefore, the permission information records the access rights associated with the video file.

Accordingly, during the decryption phase, a user's permission can be validated based on the permission information included in the index header information of the index part of the video file, and then, the index information for the one or more frames of interest is decrypted using the key only in response to determining that the user permission is validated. For example, during the decryption process, it can be determined whether the person initiating the decryption operation has the appropriate permissions, thereby allowing subsequent decryption of index information or denying further decryption operations. If the recorded permission does not match the current user, decryption operations of the video file (including all subsequent processes, such as de-obfuscating the obfuscated frame identifier information and removing the encryption marks in the frame header information of the data part 203, which will be described hereinafter in combination with FIG. 2D), are prohibited. If the permission matches, the decryption process continues to the next step.

As an illustrative example, the permission information of a user having a certain level of permission for the video access is recorded at the time of, for example, when the user sets the encryption key for the video file and selects to enable the encryption feature, which indicates or implies that the video file encrypted at this point of time belongs to users with such permissions (e.g., a user with access to all deployment locations and all capturing times of the cameras, i.e., the highest level of permission). If the current user, who wants to initiate the decryption operation of the video file, is limited to a lower level of permission of viewing video of only certain camera locations and/or only certain capturing periods (i.e., ordinary level of permission), decryption will be denied due to lack of enough permission. It is understood that other methods of setting permission information in the index header information can also be employed, and the present disclosure is not limited to the afore-mentioned examples.

In a third aspect of the embodiment, the index header information includes a key identifier (ID) corresponding to the key. It is understood that the key ID to be inserted can be obtained based on a mapping relationship between a plurality of key identifiers and a plurality of corresponding keys. Accordingly, by saving only the key ID rather than the actual key in the index header information, the security of the encrypted file is not compromised since the key in not stored in the encrypted video file in plaintext. Instead, the specific encryption key can be located and obtained through the key ID. For example, during the decryption phase, the key for decrypting the index information for the one or more frames of interest can be determined based on the key identifier included in the index header information and the mapping relationship between a plurality of key identifiers and a plurality of corresponding keys. The mapping process of keys and key IDs, as well as key management, will be described later.

In the embodiment, an index header information can be added for each frame of interest (e.g., before the encrypted index information of each frame of interest), including one or more of the afore-mentioned encryption status, permission information, and key identifier. Alternatively, since multiple frames of interest may share a common key, encryption status, and permission, the index header information can be common to the one or more frames of interest and included only once at the beginning of the index part, as indicated by the dashed box in reference numeral 205-b, which can be omitted as shown. For example, a common index header information can be used for the video file to be encapsulated based on video streams captured within a certain time frame (e.g., 1 minute, 1 hour, etc.), thereby saving file space and simplifying and reducing the processing required to repeatedly insert index header information.

FIG. 2D illustrates a schematic diagram of a third example of encrypting a video file based on an encapsulation format according to an embodiment of the present disclosure.

As depicted in scenario 200-D of FIG. 2D, the video encryption processing described in FIG. 2D is fundamentally similar to that in FIGS. 2B and 2C, all being conducted based on a video encapsulation format. Specifically, in the index part 202 of FIG. 2D, index information for frames of interest is encrypted, and index header information is added for frames of interest. The difference between FIGS. 2D and 2C lies in the further processing of the frame header information in the data part 203 for the frames of interest, for example, the encoding parameters (such as the frame identification information) in the frame header information of the data part is obfuscated, and an encryption mark is inserted in the reserved bits of the frame header information of the data part, while the frame data information of the data part still remains unchanged during the encryption process. It is understood that although FIG. 2D is illustrated with the inclusion of index header information, the processing in the data part 203 of FIG. 2D can be performed without the index header information.

As described in FIG. 2D and as indicated by reference numeral 207, an encryption mark can be inserted in the frame header information for each frame of interest in the data part 203, such as in the reserved bits, as shown by "Encryption Mark". For example, a pre-defined string or specific bit values can be used to represent this encryption mark, and the present disclosure does not limit the specific bit values thereof, as long as it conveys its meaning of adding an encryption mark for a particular frame of interest.

As indicated by reference numeral 206, the frame identification information of the frame header information for each frame of interest in the data part 203 can be obfuscated, as shown by "Obfuscated Frame Identification Info". For example, various methods can be used for obfuscating the frame identification information.

As a first example of obfuscating the frame identification information, assuming that existing protocols use different values in the frame identification field to indicate corresponding frame types, such as value 0 for B-frames, value 1 for P-frames, and value 2 for I-frames, a preset obfuscation rule can be applied in the present disclosure, obfuscating the value 0 for B-frames to value 3, the value 1 for P-frames to value 5, and the value 2 for I-frames to value 4. In this way, attackers, when reading the content of the bit values of the frame identification field, will be confused and unable to parse and identify the correct frame types (such as I-frame, P-frame and B-frame), preventing them from proceeding to read the detailed frame data contained in the frame data information of the data part 203 following the frame header information of the data part 203.

As another example of obfuscating the frame identification information, a pre-agreed key (which can be the same or different from the key used to encrypt index information) can be used, and various known encryption algorithms, such as AES (Advanced Encryption Standard), DES (Data Encryption Standard), SHA (Secure Hash Algorithm), MD5 (Message Digest Algorithm 5), etc., can be employed to encrypt the frame identification information for realizing the obfuscating function. This prevents attackers from understanding the meaning of the encrypted frame identification information, thus thwarting further attempts to crack the video file. Of course, the above methods for obfuscating frame identification information are merely examples, and the present disclosure is not limited thereto.

Accordingly, during video file decryption, the encryption mark can be removed for the frame header information for each frame of interest, and the obfuscated frame identification information for the frame header information for each frame of interest can be de-obfuscated, based on the same de-obfuscation rules used for obfuscation rules as above, thus allowing the correct frame identification information to be recovered from the obfuscated information.

For instance, for key I-frames obtained after being encoded in the video stream, during the encapsulation phase, for the data part 203 of the encapsulation format and as for the I-frames of interest, an encryption mark (as indicated by reference numeral 207) is added in the reserved bits in the frame header information, and the frame identification information in the frame header is obfuscated (as indicated by reference numeral 206). Then, when generating index information in the index part 202 of the encapsulation format, for each frame of interest (i.e., frames identified with the aid of the added encryption mark 207), the index information thereof can be encrypted using an encryption key, and the index header information is also added to record permission information, key ID, and encryption status of the frame, etc.

Subsequently, when decrypting the encrypted video file, the permission information in the index header information of the index part of the encapsulation format can be parsed first to validate the current operator's permission. If the current user's permission does not match the permission information indicated in the index header information of the index part, further decryption operations are denied; if there is a match, the process continues to the next step. Thereafter, the encryption key is determined based on the key ID in the index header information, and then the index information of each frame of interest is decrypted using the determined key. Following this, according to the decrypted index information or originally unencrypted index information of each frame, the video information (including frame header information and frame data information) for each frame can be located and accessed, so as to remove the encryption mark from the frame header information of the data part 203 and de-obfuscate the frame identification information in the frame header identification information, thus completing the decryption for local or remote viewing of the decrypted video stream.

According to the embodiment, in addition to processing the index part202 (e.g., encrypting index information and adding index header information), the data part203 is also processed (i.e., obfuscating the frame identification information and adding encryption marks in frame header information). In this way, even if an attacker bypasses the existing guideline of "first obtaining index information, then finding video information based on the index information, and finally assembling video stream based on the video information" for video data extraction and brute-force traverses the video file (without relying on index information), they would still rely on the frame identification information in the frame header of the data part to assemble a complete video stream. However, since the frame identification information is obfuscated in the present disclosure, unauthorized users cannot interpret the specific meaning of the obfuscated frame identification information, and also the addition of the new encryption marks in the reserved bits of the frame header information also prevents successful file parsing, rendering such brute-force attempts ineffective, thereby further ensuring the security of the encrypted video file. However, it should be noted that although the present disclosure processes the data part, it only targets the frame header information in the data part and does not process the actual frame data information of the data part (which contains a large amount of data), thus not causing significant encryption and decryption computational overhead. In this way, security is enhanced without significantly increasing the overhead of encryption and decryption.

It is understood that, although the above example uses the frame identification information in the frame header to illustrate enhanced encryption security through obfuscation, the present disclosure can also obfuscate various information other than frame identification information in the frame header. For example, as an alternative or supplement to obfuscating frame identification information, coding parameters such as Sequence Parameter Set (SPS) and Picture Parameter Set (PPS) can also be obfuscated. Depending on requirements for encryption and decryption overhead and waiting time, any one or more of the above-mentioned coding parameters in the frame header information can be obfuscated. Of course, the simplest and most effective method is to obfuscate the frame identification information to prevent attackers from successfully parsing content of frame data due to the failure to identify the frame type thereof.

FIG. 3 illustrates a schematic diagram of generating a key for encrypting a video file according to an embodiment of the present disclosure.

As previously mentioned, the present disclosure proposes generating an encryption/decryption key based on both the device information of a capturing device (e.g., a surveillance camera) and the user information (e.g., user-input string, or other information that is configurable by the user), such that the security of the encrypted video files is enhanced.

As shown in scenario 300 of FIG. 3, the key generation process requires a combination of device information of the capturing device 302 (e.g., MAC address, device serial number, etc.) and user information obtained from user 301, which is configurable by the user, to generate a key for encryption or decryption of the video files. For example, the user information can be concatenated with the device information to form the key. Optionally, the concatenated information obtained based on the device information and the user information can be further encrypted using various encryption algorithms like SHA or MD5 to generate the key, thereby ensuring that the original device and user information is not revealed for ensuring the safety of the related information. Additionally, users can dynamically update the key as needed, e.g., by selecting one type of device information from multiple types of device information unique to the device, and/or by changing the user-input string. For example, when the user enables the encryption feature for a particular video file in the interface for managing the capturing device (such as an APP installed on the PC or mobile device of the user for managing and configuring the camera), the interface provided for the user allows the user to enter an encryption password, and this information is passed to the device as the user information to be combined with device information for generating the key.

Furthermore, since many keys will be generated during use of the capturing device, a mapping relationship between keys and their key identifiers (IDs) can be established and stored on the capturing device for efficient key management. For instance, the mapping relationship for each key and its key ID which is set and used by one or more users is maintained in the capturing device as well as other computing devices which has a requirement for encrypting or decrypting video files for subsequent use in the process of video encryption and decryption. For example, the present disclosure can support users in changing keys in real-time, with each video file encrypted using the most recent key (as changed by the user at any time) as indicated by the user, e.g., a default key can be used automatically for a period of time for encrypting video files unless otherwise instructed by the user, or a new key can be generated each time of encrypting a video file. Thus, a mapping relationship is established at the capturing device or other computing device for all the historical keys and newly generated keys for management purposes. Additionally, newly generated keys based on the device information and the user information are also added in the established mapping relationship at any time, thereby continuously updating the key-key ID mapping table.

For example, the key identifier information may refer to the index value in the key mapping relationship management table described above, and the key is the actual key used to encrypt or decrypt the video files. Thus, after verifying the user permissions, the key ID in the index part (e.g., the Key ID as shown in FIG. 2C) is extracted, and the actual key is found in the mapping table based on this, and then the key is used to decrypt the data.

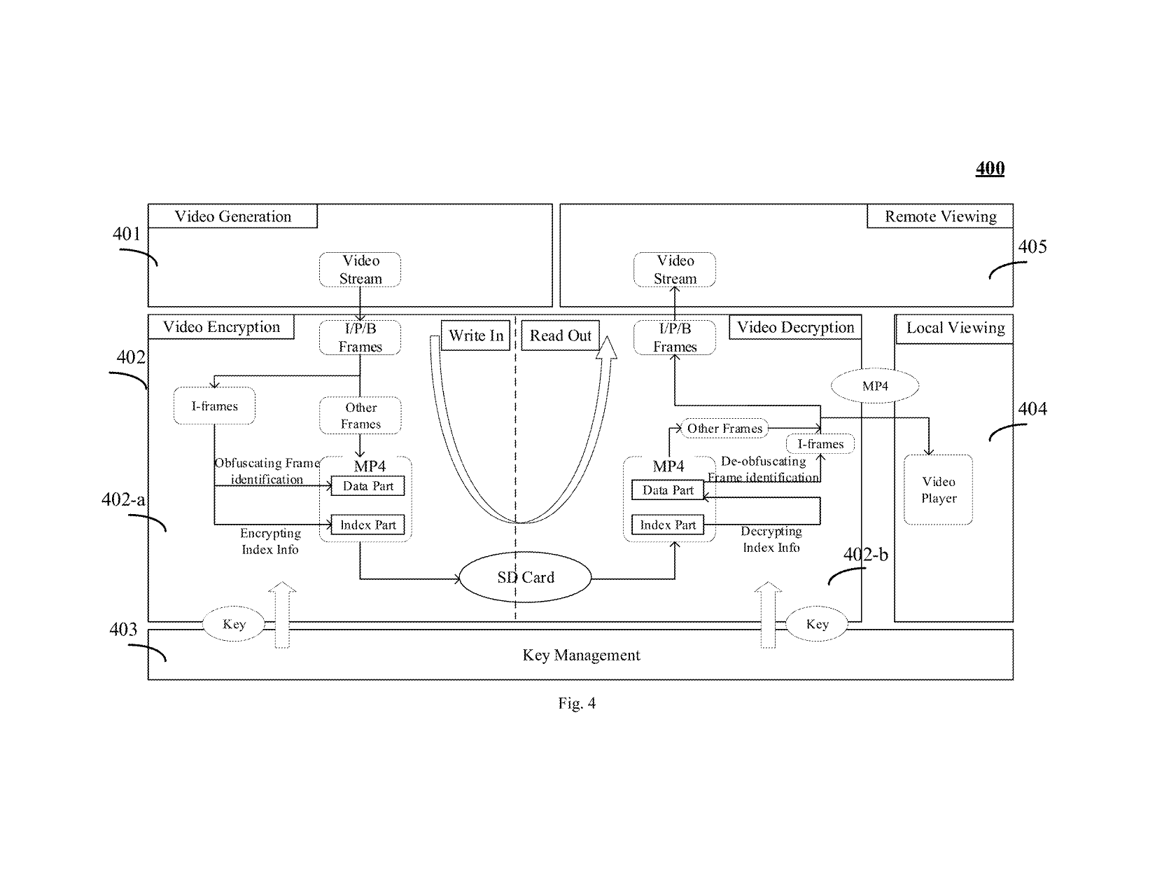

FIG. 4 illustrates a schematic diagram of encrypting and decrypting a video file based on an encapsulation format according to an embodiment of the present disclosure.

As shown in the surveillance system 400 of FIG. 4, a surveillance system with video file encryption/decryption features is provided, which is primarily divided into: a video information generation module 401, a video information encryption & decryption module 402 (comprising a video encryption module 402-a and a video decryption module 402-b), a key management module 403, a local viewing module 404, and a remote viewing module 405. The modules may correspond to various components of the video capturing device and other computing devices of the users and used to perform encryption/decryption related operations.

Video information generation module 401 is configured to capture real-time video streams based on various camera policies (e.g., according to specific capture parameters, resolution parameters, shooting angles, etc.). For instance, the video information generation module 401 can provide encoded video streams (including video data of I-frames, P-frames, and B-frames) obtained e.g., by encoding raw video data captured by a video capturing device using various coding techniques for encryption by the video encryption module 402-a.

Key management module 403 is configured to manage keys (e.g., based on the mapping relationship with key IDs as mentioned above) at the video capturing device and to provide the keys used for encryption or decryption of the video files.

The video information encryption & decryption module 402 is configured to perform encryption/decryption related processing essentially the same as described in the FIGS. 2B-2D, and thus its description will be simplified.

Video encryption module 402-a is configured to generate index information and video information for each of a plurality of frames (I-frames, B-frames and P-frames) of a video file to be encrypted based on the video data for each of the plurality of frames, which may be obtained from the video information generation module 401 as video streams. Next, the video encryption module 402-a is configured to encapsulate the index information and the video information for each of the plurality of frames (I-frames, B-frames and P-frames) into an encapsulation format of the video file and proceed with encryption related processing on the I-frames only while leaving other frames (P-frames and B-frames) unprocessed in the encapsulation format. For example, the video encryption module 402-a is configured to identify frames of interest (such as I-frames) from the obtained video stream and perform the actions of encryption mark insertion (not shown) in the frame header information of the data part of the encapsulation format and obfuscation of the frame identification information for the identified frames of interest. Correspondingly, for the frames of interest (I-frames) carrying the encryption mark in the frame header information, two steps are taken when generating their index data: 1) adding index header information to the index part of the index part of the encapsulation format of the video file, which records the encryption status, permission information, and key ID of the corresponding frame of interest; 2) encrypting the index information for each frame of interest in the index part of the encapsulation format of the video file with a key that matches the key ID indicated in the index header information. After completion, the encapsulated and encrypted video file can be written into the storage medium of the capturing device, such as stored on the SD card of the camera.

Video decryption module 402-b is configured to perform processing corresponding to that of the video encryption module 402-a. Detailed description is omitted here. For example, video decryption module 402-b is configured to read out a video file encapsulated using an encapsulation format, e.g., from the SD card of the camera, which may be previously encrypted by the video encryption module 402-a and stored in the SD card. Then, video decryption module 402-b is configured to decapsulate index information and video information for each of a plurality of frames (I-frames, B-frames and P-frames) included in the video file according to the encapsulation format, wherein the index information of one or more frames of interest (I-frames) is encrypted using a key. Next, the video decryption module 402-b is configured to proceed with decryption related processing on the I-frames only while leaving other frames (P-frames and B-frames) unprocessed in the encapsulation format.

For example, when a user selects to remotely view video files stored on the camera's storage medium (e.g., through the user remote viewing module 405, such as with the help of the APP running on the user’s mobile phone), the video decryption module 402-b, for frames of interest (I-frames), first obtains the index information in the index part of the encapsulation format. If the index header information in the index part of the encapsulation format identifies an encryption status of "yes", video decryption module 402-b then verifies the current user's permissions based on the permission information indicated in the index header information of the index part. If the verification is successful, the video decryption module 402-b uses the key corresponding to the key ID indicated in the index header information of the index part to decrypt the index information, thereby locating the video data corresponding to that piece of index information. Next, the video decryption module 402-b proceeds with removing the encryption mark from the frame header information in the data part of the encapsulation format , and de-obfuscating the obfuscated frame identification information the frame header information in the data part. Accordingly, the video information of each of the plurality of frames (I-frames, B-frames and P-frames) can be obtained based on the index information of the frame, and video data for each frame (I-frames, B-frames and P-frames) can be obtained by parsing the frame header information of the data part of the encapsulation format and recovering the frame data information accordingly. Then, the video decryption module 402-b concatenates the video data for each frame (I-frames, B-frames and P-frames) to generate a decrypted video stream, which can be pushed to the user via video streaming.

When a user chooses to directly access video files stored on the storage medium of the capturing device for viewing (e.g., through the user local viewing module 404, such as by copying the video file on the PC of the user), the same decryption operation as described above is performed locally on the camera for decryption of the video files. For example, after successful authentication of the user’s permission, the key provided by the key management module maintained at the capturing device is used to decrypt the corresponding index information of the index part of the encapsulation format for frames of interest, to jump to the video information for each of the frames based on the decrypted index information of frames of interest and original unencrypted index information of remaining frames, and then to de-obfuscate the obfuscated frame identification information in the frame header information in the data part of the encapsulation format for frames of interest, and to remove the encryption mark from the frame header information in the data part of the encapsulation format for he frames of interest, and then the resulting index information and video information in the encapsulation format is rewritten back to the storage medium, enabling it to be recognized and parsed by common video players running on the user’s computing device (e.g., after the decrypted video file is copied to the user’s other computing devices) for local viewing.

It is noted that the specific descriptions in FIG. 4 are exemplary and not limiting.

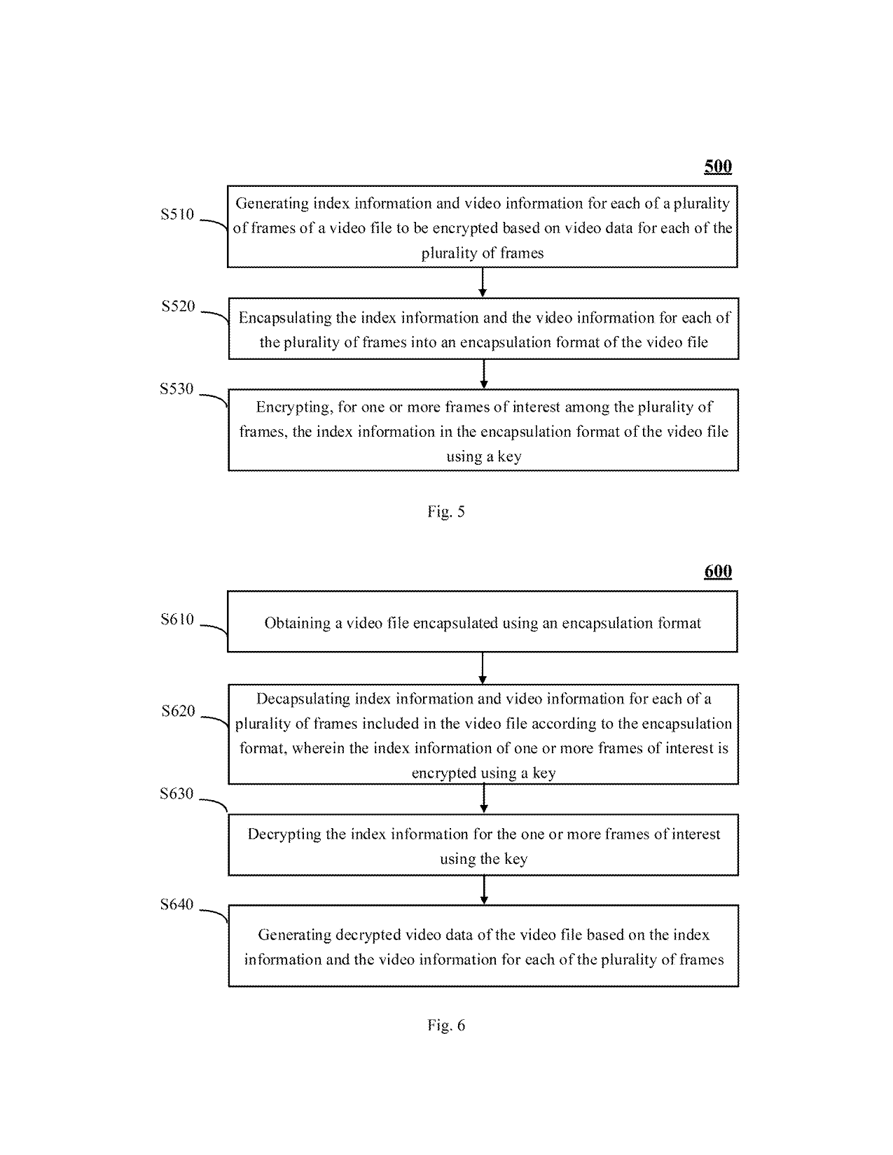

FIG. 5 illustrates a flowchart of a computer-implemented method for encrypting a video file according to an embodiment of the present disclosure.

The method may be implemented in the capturing device and other types of computing devices with the need for video file encryption and the detailed description of method 500 can refer to the content described in the above with respect to FIGS. 1-4. For example, method 500 can be executed in the architecture described with respect to FIGS. 1-4. In addition, each step of method 500 can be performed by one or more processing units, such as central processing unit (CPU) of the computing device.

With reference to FIG. 5, method 500 comprises steps S510-S530.

At step S510, the computing device may generate index information and video information for each of a plurality of frames of a video file to be encrypted based on video data for each of the plurality of frames.

At step S520, the computing device may encapsulate the index information and the video information for each of the plurality of frames into an encapsulation format of the video file.

At step S530, the computing device may encrypt, for one or more frames of interest among the plurality of frames, the index information in the encapsulation format of the video file using a key.

According to an embodiment, the plurality of frames of the video file comprise one or more intra frames (I-frames), one or more predictive frames (P-frames), and one or more bi-directional predictive frame (B-frames), and wherein the one or more frames of interest comprise the one or more I-frames.

According to an embodiment, the encapsulation format comprises: a file header; an index part including the index information for each of the plurality of frames; and a data part including the video information for each of the plurality of frames.

According to an embodiment, the computing device may add index header information in the index part for the one or more frames of interest.

According to an embodiment, the key identifier is obtained based on a mapping relationship between a plurality of key identifiers and a plurality of corresponding keys.

According to an embodiment, the index header information includes permission information for the video file to be encrypted.

According to an embodiment, the index header information includes an encryption status for the one or more frames of interest.

According to an embodiment, the index header information is common to the one or more frames of interest and included at a beginning of the index part.

According to an embodiment, the video information of the data part of the encapsulation format comprises frame header information followed by frame data information for each of the plurality of frames, and the frame header information includes at least frame identification information. In this embodiment, the computing device may further insert an encryption mark and obfuscating the frame identification information for the frame header information for each frame of interest.

According to an embodiment, the key is generated based on device information of a video capturing device and user information.

According to an embodiment, the user information is configurable by a user.

According to an embodiment, the video data for each of the plurality of frames of the video file is obtained by encoding raw video data captured by a video capturing device.

FIG. 6 illustrates a flowchart of a computer-implemented method for decrypting a video file according to an embodiment of the present disclosure.

The method may be implemented in the capturing device and other types of computing devices with the need for video file decryption and the detailed description of method 600 can refer to the content described in the above with respect to FIGS. 1-4. For example, method 600 can be executed in the architecture described with respect to FIGS. 1-4. In addition, each step of method 600 can be performed by one or more processing units, such as central processing unit (CPU) of the computing device.

With reference to FIG. 6, method 600 comprises steps S610-S640.

At step S610, the computing device may obtain a video file encapsulated using an encapsulation format.

At step S620, the computing device may decapsulate index information and video information for each of a plurality of frames included in the video file according to the encapsulation format. Specifically, the index information of one or more frames of interest is encrypted using a key during the encryption process as mentioned above in FIG. 5.

At step S630, the computing device may decrypt the index information for the one or more frames of interest using the key.

At step S640, the computing device may generate decrypted video data of the video file based on the index information and the video information for each of the plurality of frames.

According to an embodiment, the plurality of frames of the video file comprise one or more intra frames (I-frames), one or more predictive frames (P-frames), and one or more bi-directional predictive frame (B-frames), and wherein the one or more frames of interest comprise the one or more I-frames.

According to an embodiment, the encapsulation format comprises: a file header; an index part including the index information for each of the plurality of frames; and a data part including the video information for each of the plurality of frames.

According to an embodiment, the index part of the encapsulation format further comprises index header information for the one or more frames of interest, the index header information comprises a key identifier. In this embodiment, the computing device may further determine the key for decrypting the index information for the one or more frames of interest based on the key identifier included in the index header information and a mapping relationship between a plurality of key identifiers and a plurality of corresponding keys.

According to an embodiment, the index part of the encapsulation format further comprises index header information for the one or more frames of interest, the index header information comprises permission information for the video file. In this embodiment, the computing device may further validate a user permission based on the permission information included in the index header information of the index part, and wherein the index information for the one or more frames of interest is decrypted using the key in response to determining that the user permission is validated.

According to an embodiment, the video information of the data part of the encapsulation format comprises frame header information followed by frame data information for each of the plurality of frames, the frame header information includes at least frame identification information, and wherein the frame header information of each frame of interest includes obfuscated frame identification information and an encryption mark. In this embodiment, the computing device may further remove the encryption mark and de-obfuscate the obfuscated frame identification information for the frame header information for each frame of interest.

According to an embodiment, the computing device may further provide the decrypted video data of the video file for remote viewing or local viewing.

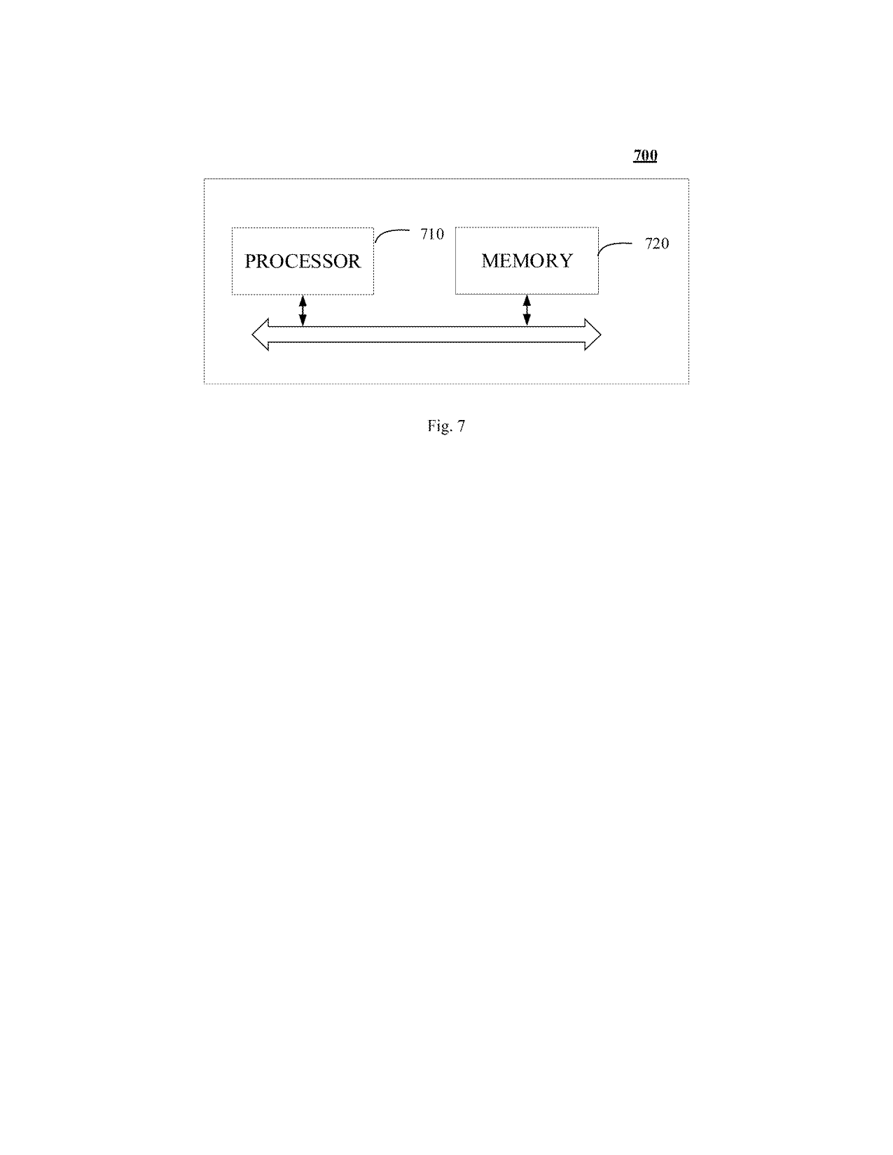

FIG. 7 is an exemplary block diagram illustrating a computing device according to embodiments of the disclosure.

It should be noted that the computing device depicted in FIG. 7 can correspond to the capturing device as described in FIGS. 1-4 as well as other types of computing devices with the need for video file encryption/decryption, such as client device, PCs or servers, and can be used to perform the actions involved in encrypting or decrypting a video file , for example, the method 500 or 600 as described above.

As shown in FIG. 7, the computing device 700 can comprise processor 710 and memory 720. The processor 710 is communicatively coupled with the memory and configured to perform the methods discussed above.

Examples of the processor 710 comprise microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout the present disclosure.

The processor 710 can execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on memory 720.

The memory 720 may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read-only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The memory 720 may reside in the processor 710, external to the processor 710, or distributed across multiple entities including the processor 710. The memory 720 may be embodied in a computer program product. By way of example, a computer program product may include a computer-readable medium in packaging materials. Those skilled in the art will recognize how to implement the described functionality presented throughout the present disclosure depending on the particular application and the overall design constraints imposed on the overall system.

In addition, according to another embodiment of the present disclosure, a computer program product for wireless communication is disclosed. As an example, the computer program product comprises a non-transitory computer readable storage medium having program instructions embodied therewith, and the program instructions are executable by a processor. When executed, the program instructions cause the processor to perform one or more of the above described procedures, and details are omitted herein for conciseness.

The present disclosure may be a system, a method, and/or a computer program product at any possible technical detail level of integration. The computer program product may include a computer readable storage medium (or media) having computer readable program instructions thereon for causing a processor to carry out aspects of the present disclosure.

Expression such as “according to”, “based on”, “dependent on”, and so on as used in the disclosure does not mean “according only to”, “based only on”, or “dependent only on”, unless it is explicitly otherwise stated. In other words, such expression generally means “according at least to”, “based at least on”, or “dependent at least on” in the disclosure.

Any reference in the disclosure to an element using the designation “first”, “second” and so forth is not intended to comprehensively limit the number or order of such elements. These expressions can be used in the disclosure as a convenient method for distinguishing two or more units. Thus, a reference to a first unit and a second unit does not imply that only two units can be employed or that the first unit must precede the second unit in some form.

The term “determining” used in the disclosure can include various operations. For example, regarding “determining”, calculating, computing, processing, deriving, investigating, looking up (e.g., looking up in tables, databases, or other data structure), ascertaining, and so forth are regarded as "determination". In addition, regarding “determining”, receiving (for example, receiving information), transmitting (for example, transmitting information), input, output, accessing (for example, access to data in the memory), and so forth, are also regarded as “determining”. In addition, regarding “determining”, resolving, selecting, choosing, establishing, comparing, and so forth can also be regarded as “determining”. That is, regarding "determining", several actions can be regarded as “determining”.

The terms such as “connected”, “coupled” or any of their variants used in the disclosure refer to any connection or combination, direct or indirect, between two or more units, which can include the following situations: between two units that are “connected” or “coupled” with each other, there are one or more intermediate units. The coupling or connection between the units can be physical or logical, or can also be a combination of the two. As used in the disclosure, two units can be considered to be electrically connected through the use of one or more wires, cables, and/or printed, and as a number of non-limiting and non-exhaustive examples, and are “connected” or “coupled” with each other through the use of electromagnetic energy with wavelengths in a radio frequency region, the microwave region, and/or in the light (both visible and invisible) region, and so forth.

When used in the disclosure or the claims ‘including”, “comprising”, and variations thereof, these terms are as open-ended as the term “having”. Further, the term “or” used in the disclosure or in the claims is not an exclusive-or.

The present disclosure has been described in detail above, but it is obvious to those skilled in the art that the present disclosure is not limited to the embodiments described in the disclosure. The present disclosure can be implemented as a modified and changed form without departing from the spirit and scope of the present disclosure defined by the description of the claims. Therefore, the description in the disclosure is for illustration and does not have any limiting meaning to the present disclosure.

What is claimed is:

1. A method for encrypting a video file, comprising:
generating index information and video information for each of a plurality of frames of a video file to be encrypted based on video data for each of the plurality of frames;
encapsulating the index information and the video information for each of the plurality of frames into an encapsulation format of the video file; and
encrypting, for one or more frames of interest among the plurality of frames, the index information in the encapsulation format of the video file using a key.

2. The method of claim 1, wherein the plurality of frames of the video file comprise one or more intra frames (I-frames), one or more predictive frames (P-frames), and one or more bi-directional predictive frame (B-frames), and wherein
the one or more frames of interest comprise the one or more I-frames.

3. The method of claim 1, wherein the encapsulation format comprises:
a file header;
an index part including the index information for each of the plurality of frames; and
a data part including the video information for each of the plurality of frames.

4. The method of claim 3, further comprising:
adding index header information in the index part for the one or more frames of interest.

5. The method of claim 4, wherein the index header information includes a key identifier corresponding to the key.

6. The method of claim 5, wherein the key identifier is obtained based on a mapping relationship between a plurality of key identifiers and a plurality of corresponding keys.

7. The method of claim 4, wherein the index header information includes permission information for the video file to be encrypted.

8. The method of claim 4, wherein the index header information includes an encryption status for the one or more frames of interest.

9. The method of claim 4, wherein the index header information is common to the one or more frames of interest and included at a beginning of the index part.

10. The method of claim 3, wherein
the video information of the data part of the encapsulation format comprises frame header information followed by frame data information for each of the plurality of frames, and the frame header information includes at least frame identification information,
the method further comprising:
inserting an encryption mark and obfuscating the frame identification information for the frame header information for each frame of interest.

11. The method of claim 1, wherein the key is generated based on device information of a video capturing device and user information.

12. The method of claim 11, wherein the user information is configurable by a user.

13. The method of claim 1, wherein the video data for each of the plurality of frames of the video file is obtained by encoding raw video data captured by a video capturing device.

14. A method for decrypting a video file, comprising:
obtaining a video file encapsulated using an encapsulation format;
decapsulating index information and video information for each of a plurality of frames included in the video file according to the encapsulation format, wherein the index information of one or more frames of interest is encrypted using a key;
decrypting the index information for the one or more frames of interest using the key; and
generating decrypted video data of the video file based on the index information and the video information for each of the plurality of frames.

15. The method of claim 14, wherein the encapsulation format comprises:
a file header;
an index part including the index information for each of the plurality of frames; and
a data part including the video information for each of the plurality of frames.

16. The method of claim 15, wherein the index part of the encapsulation format further comprises index header information for the one or more frames of interest, the index header information comprises a key identifier, the method further comprising:
determining the key for decrypting the index information for the one or more frames of interest based on the key identifier included in the index header information and a mapping relationship between a plurality of key identifiers and a plurality of corresponding keys.

17. The method of claim 15, wherein the index part of the encapsulation format further comprises index header information for the one or more frames of interest, the index header information comprises permission information for the video file, the method further comprising:
validating a user permission based on the permission information included in the index header information of the index part, and wherein
the index information for the one or more frames of interest is decrypted using the key in response to determining that the user permission is validated.

18. The method of claim 15, wherein
the video information of the data part of the encapsulation format comprises frame header information followed by frame data information for each of the plurality of frames, the frame header information includes at least frame identification information, and
wherein the frame header information of each frame of interest includes obfuscated frame identification information and an encryption mark, and
the method further comprising:
removing the encryption mark and de-obfuscating the obfuscated frame identification information for the frame header information for each frame of interest.

19. The method of claim 14, further comprising:
providing the decrypted video data of the video file for remote viewing or local viewing.

20. A device for encrypting a video file, comprising:
one or more processors;
a memory coupled to at least one of the processors; and
a set of computer program instructions stored in the memory, which, when executed by at least one of the processors, perform actions of:
generating index information and video information for each of a plurality of frames of a video file to be encrypted based on video data for each of the plurality of frames;
encapsulating the index information and the video information for each of the plurality of frames into an encapsulation format of the video file; and
encrypting, for one or more frames of interest among the plurality of frames, the index information in the encapsulation format of the video file using a key.
